(19) United States
(12) Patent Application Publication
(10) Pub. No.: US 2023/0347725 A1
(43) Pub. Date: Nov. 2, 2023

(54) Storable, Foldable And Removable Three-Part Pickup Truck Rear Side Cover

(71) Applicant: Arthur Smith, Fairfax, CA (US)

(72) Inventor: Arthur Smith, Fairfax, CA (US)

(21) Appl. No.: 18/128,523

(22) Filed: Mar. 30, 2023

Related U.S. Application Data
(60) Provisional application No. 63/323,251, filed on Mar. 24, 2022.

(51) Int. Cl. B60J 11/06

(52) U.S. Cl. CPC B60J 11/06

(57) ABSTRACT

This invention provides a pickup truck rear side panel cover comprised of at least three attached pieces with the cover comprising one layer of material. The cover fits all, or substantially all, of the outside, optionally the top rail, and optionally the inside of the top rail of the driver side and/or passenger side rear side panel. The cover is foldable, temporary, not permanently affixed, easily removable, easily storable by folding it up to a volume of less than 3 cubic feet, and not for highway use, and it can be quickly and easily installed (and uninstalled) while the pickup truck is stationary. The cover shields a rear side panel of the pickup truck while loading and/or unloading the bed of the pickup truck and thereby it protects the rear side panel of the pickup truck from damage such as scratches and dents from falling debris while loading and/or unloading the bed of the pickup truck.

### CROSS REFERENCE TO RELATED APPLICATIONS

This application claims the benefit of U.S. Provisional Application Ser. No. 63/323,251, filed on Mar. 24, 2022, which is hereby incorporated by reference herein.

### FIELD OF THE INVENTION

The invention relates to protectors for the outside of pickup trucks near the bed area of the pickup truck.

### BACKGROUND OF THE INVENTION

The loading and unloading of the bed of a pickup truck may cause damage to the rear side panel of the pickup truck, such as scratches and dents caused by falling debris that is being put into or taken out of the pickup bed on the side. Currently, the most common solution is to put a blanket on the rear side panel while loading or unloading. However, the blanket may fall off and/or it may not provide enough protection. Better pickup truck rear side panel protection is needed.

### SUMMARY OF THE INVENTION

This invention provides a pickup truck rear side panel cover that is comprised of at least three parts (also referred to as interlocking structures, pieces, panels, sections or portions) and it is foldable, temporary, not permanently affixed, easily removable, and easily storable. In a preferred embodiment, the cover fits all, or substantially all, of the outside, top rail, and inside rail of the driver side or passenger side rear side panel. In a different preferred embodiment, the cover fits all, or substantially all, of the outside of the driver side or passenger side rear side panel, and, in some embodiments, at least a portion of the top rail.

The cover stays in place on a rear side panel of the pickup truck while the pickup truck is stationary for loading and/or unloading the bed of the pickup truck and thereby it protects the rear side panel of the pickup truck from damage such as scratches and dents from falling debris. The cover is easily installed and uninstalled (i.e., easily removable (although any attachment hardware may take more time to initially install in certain embodiments)) and storable for when the pickup truck is finished being loaded and/or unloaded and it is driven away (e.g., on the highway).

In certain preferred embodiments of this invention, the cover fits all, or substantially all, of the outside, top rail, and inside rail of the rear side panel. This shape, which may roughly form an upside down “J” or upside down “U” shape, is a feature of these embodiments of this invention because it helps the cover to stay in place, and not fall off, while the pickup truck bed is being loaded.

In different preferred embodiments of this invention, the cover fits all, or substantially all, of the outside of the rear side panel, and at least a portion of the top rail. This shape roughly forms an upside down “L” or upside down “J”. The outside portion in these embodiments is connected to the top rail portion by an interlocking structure comprised of two interlocking pieces (e.g., shapes that fit within one another to removably join them together). There may also be a portion that covers a portion of the inside of the bed, forming a “J” shape, but this is only in some of these embodiments. In particularly preferred embodiments, the first interlocking piece is comprised of a solid tube piece that is attached along its length to the top rail portion. In these embodiments, the second interlocking piece is comprised of a hollow, partial circle round piece. This hollow, partial circle round piece fits over the solid tube piece and is held in place by the solid tube piece. This hollow, partial circle round piece is attached along its length to the top of the outside portion. In these embodiments, the portion on the top rail portion is held in place on the top rail. This may be done with detachable hardware, a portion attached to it and hanging on the inside of the bed, or, more preferably, by using a strong, durable fabric for the top rail piece and fitting it under the plastic protector (i.e., often referred to as a bed rail cap) that is attached to the top rails of many pickup truck beds.

In still different preferred embodiments of this invention the cover fits all, or substantially all, of the outside of the rear side panel of a pickup truck that has a bed rail cap (e.g., provided by the manufacturer or purchased on the secondary market). The outside portion of the cover in these embodiments is connected directly to the bed rail cap. In the particularly preferred embodiments, the connection of the outside portion of the cover to the bed rail cap is affected by an interlocking structure comprised of two interlocking pieces that fit together. One example of an interlocking structure of two interlocking pieces that fit together is a hollow trapezoid and a solid trapezoid wherein the solid trapezoid fits into the hollow trapezoid to hold it in place. Another example of an interlocking structure comprised of two pieces that fit together is a hollow tube and a solid rod that fits into the hollow tube to hold it in place. Another example of an interlocking structure comprised of two pieces that fit together is a channel shape (e.g., a notch, gutter or channel along the length of the cap) and a hanger shape (e.g., a lip or protrusion along the length of the outer portion of the cover) that fits into the channel shape. The first interlocking piece is attached to or part of the outside (i.e., away from the center of the bed) length of the bed rail cap (e.g., a grove or other shape molded into or attached to the length of the bed rail cap) while the second interlocking piece is attached to or part of the top length of the outside portion of the cover. The second interlocking piece is then fitted by the user to the first interlocking piece which, when fully fitted to one another, attaches the outside portion of the cover to the pickup bed rail cap and protects the side of the pickup truck from scratches and other damage.

In certain embodiments of this invention, attachment hardware is also used to secure the rear side panel cover to the pickup truck in a temporary fashion so that the cover is easily installed and uninstalled, easily stored by folding it into a smaller size, and removed before traveling down a road or highway for more than an insubstantial distance.

Advantages of this invention are identified herein and/or will be apparent to a person skilled in the art. The preferred embodiments of this invention protect the outside and the top rail a pickup truck rear side panel from scratches, abrasions, dents and other damage that may be caused by the loading and unloading of debris and other things and/or materials into or out of the bed of the pickup truck.

Advantages also include that the cover is temporarily installed and not permanently affixed, that it is one-layer of material in the form of two or three parts (with at least two panels or portions) that are attached together, which, in some embodiments, aids in the foldability and storage of the cover, and applies so that the cover is easily removable (i.e., can be uninstalled in less than a minute by an average adult person and any attachment hardware is not used to permanently attach the cover to the pickup truck (e.g., hook and loop fasteners, held in place under the plastic top rail protector on may pickup trucks)), and easily storable in the pickup truck if desired (e.g., at least the outside portion folds up to a volume of less than 3 cubic feet) before the pickup truck is driven on the highway or on the road for more than an insubstantial distance.

### BRIEF DESCRIPTION OF THE DRAWINGS

FIG. 1 is a drawing of a pickup truck showing scratch damage to the driver side rear side panel that this invention is designed to reduce or avoid.

FIG. 2 is a drawing of two exemplary embodiments of this invention; the top drawing is from a front (the viewer looking from outside the bed into the bed), partially off center viewpoint of a driver side rear side panel cover of this invention; and the bottom drawing is from a back (the viewer looking from inside the bed to outside of the bed), partially off center viewpoint of a passenger side rear side panel cover of this invention.

FIG. 3 is a drawing of two exemplary embodiments of this invention, each from a front (the viewer is looking from outside the bed into the bed), partially off center viewpoint of two driver side rear side panel covers of this invention.

FIG. 4 contains drawings of a cross-section of an example of certain preferred embodiments of this invention, comprising a driver side rear side panel of this invention. This figure provides a cross-section view of components before they are attached to one another, comprising an outside portion with a hollow, partial circle round piece attached shown on the left side, and a top rail portion with a solid tube piece attached shown on the right side.

FIG. 5 is a drawing from a front, partially off center viewpoint of a driver side rear side panel cover of this invention with the components after they are attached to one another, and hanging as they would if they were attached to a pickup truck.

FIG. 6 shows a cross-section view of another example of certain preferred embodiments of the invention, comprising a driver side rear side panel of this invention. This figure provides a cross-section view of components before they are attached to one another, comprising an outside portion with a hollow, partial oval piece attached shown on the left side, and a top rail portion with a solid tube piece attached shown on the right side. The other end of the solid tub piece contains a hollow, partial oval piece that is to be attached to a passenger side rear side cover of this invention.

### DETAILED DESCRIPTION OF THE INVENTION

This invention provides a pickup truck rear side panel cover that has at least three parts, comprised of an interlocking structure, pieces, panels, sections or portions.

In certain preferred embodiments, these parts comprise an outside portion, a top rail portion, and an inside rail portion. These three separate portions are connected (i.e., the outside portion is connected (e.g., attached (e.g., sewn, glued, riveted, welded, screwed)) to the top rail portion and the top rail portion is connected (e.g., attached (e.g., sewn, glued, riveted, welded, screwed) to the inside portion) to the inside rail portion to form one continuous cover. The outside portion, top rail portion and inside rail portions may appear to be distinct portions in certain embodiments. In other embodiments, these portions may all blend into one another and not be particularly distinct until the cover is placed on the pickup truck and the outside portion will be seen to cover the rear side panel, the top rail portion will be seen to cover the top of the top rail, and the inside portion will be seen to cover at least the inside portion of the rail.

In other preferred embodiments, these parts comprise an outside portion and a top rail portion connected to one another by an interlocking structure. In certain of these embodiments, the interlocking structure is comprised of a solid tube piece (that is preferably bendable and made of a plastic material) that interlocks along its length with a hollow, partial circle round piece (that is preferably bendable, strong enough to withstand material bumping into it, and of a rubber or rubber-like material) that is fitted to slide over the solid tube piece and which therefore is held in place by the solid tube piece. The solid tube piece, a first interlocking piece, is attached (e.g., sewn, glued, welded, screwed, or formed as one piece with the top rail portion) to the top rail portion. The hollow, partial circle round piece, a second interlocking piece, is attached (e.g., sewn, glued, welded, screwed, or formed of one piece with the outside portion) to the outside portion. A person of skill in the art will understand that this invention can use different shapes and styles (e.g., ovals, multi-sided shapes or other shapes) of interlocking structures besides the solid tube piece/hollow, partial circle round piece to accomplish the same results. In certain of these preferred embodiments, there may also be an inside rail portion attached (e.g., sewn, glued, welded, screwed, or formed as one piece with the top rail portion) to the top rail portion.

Certain of the preferred embodiments of this invention provide a cover that fits all, or substantially all, of the outside of the rear side panel of a pickup truck that has a bed rail cap. In these embodiments the outside portion of the cover has a second interlocking piece attached to it that fits together with a first interlocking piece, and the first interlocking piece is attached to or otherwise a part of the bed rail cap. When the user wants to use the cover, the user fits the first interlocking piece into the second interlocking piece and thereby deploys the cover on the rear side panel of the pickup truck. The cover is easily deployed and removed by the user by just fitting the interlocking pieces together.

In these embodiments, one of skill in the art will understand that there are many types of interlocking structures and shapes thereof that can be used (e.g., trapezoids that fit together, tubes/rods that fit together, channel/hanger that fit together). The cover is also easily stored (e.g., by rolling it up along its length). A kit may be formed by two such covers, one for the left side and one for the right side. Alternatively, the kit may be formed of one or more bed rail caps, each with the first interlocking piece attached, connected, embedded, or otherwise included, and one or more outer portion covers with the second interlocking piece attached, connected, embedded, or otherwise included. In addition, the bed rail caps with first interlocking pieces can be sold separately from the outer portion covers with second interlocking pieces.

The outer portion of the covers may be decorated, color matched with the pickup truck, or contain messages or advertisements.

In certain preferred embodiments, regardless of the number of portions or their distinctiveness, the cover fits all, or substantially all, of the outside, top rail, and inside rail of the driver side or passenger side rear side panel. This shape, which may roughly form an upside down “J”, “L”, or “U” shape, is a feature of this invention because it helps ensure that the cover will stay in place, and not fall off, while the pickup truck bed is being loaded and/or unloaded.

Certain of the preferred embodiments of this invention protect the outside, the top rail and/or the inside rail of the pickup truck rear side panel from scratches, abrasions, dents and other damage that may be caused by the loading and unloading of debris and other things and/or materials into or out of the bed of the pickup truck.

Certain embodiments of the pickup truck rear side panel cover of this invention are relatively generic, and can fit many (i.e., three or more) different types of pickup side panels. Other embodiments of the pickup truck rear side panel cover of this invention are fitted for particular makes, models, years and/or beds of pickup trucks (e.g., for each make and model and year of a type of pickup truck, a 5 foot 8 inch bed model, a 6 foot, 5 inch bed model, and an 8 foot bed model, or whatever sizes and/or series of sizes fit all of the available sizes of the side panels).

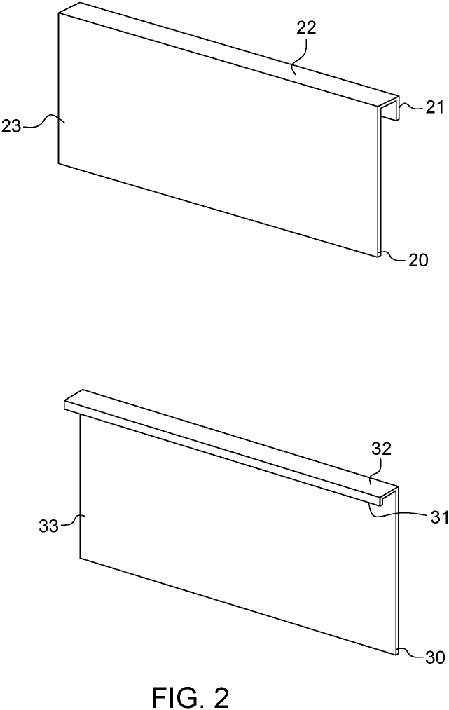

In some embodiments, including those shown in FIG. 2, there is no cut out of the cover over the rear wheel well, and these embodiments cover all or part of the rear side panel and all or part of the rear wheel well. In certain of these embodiments, not shown in the figures, there is no cut out of the cover over the rear wheel and the cover extends farther towards the ground, and these embodiments cover the rear side panel, the rear wheel well, and the rear wheel, rim and tire, protecting each from damage.

The embodiments of this invention can be made of any protective material. They can be comprised of one type of material, or a combination of two or more materials, provided that they form one-layer of material (e.g., which may aid in the folding and storage of the cover). A person of skill in the art will recognize what types of materials can be used for different applications. Some of these materials may include, but are not limited to, plastics and other polymers, leather, natural rubber, synthetic rubber, natural cloth, synthetic cloth, natural fibers, synthetic fibers (e.g., Kevlar), and other materials and/or combinations of materials known to a person of skill in the art. In certain embodiments, the material used that covers the rail is heavier. In particularly preferred embodiments, the material used is not multilayer and it consists of one layer of uniform material.

Certain embodiments of the cover of this invention may stay on the pickup truck rear side panel by their own weight. Other embodiments of the cover of this invention may stay on the pickup truck rear side panel by the top rail portion slipping under the plastic protector provided on the top rail of some pickup trucks and being held temporarily in place. Still other embodiments of the cover of this invention may stay on the pickup truck rear side panel by temporary (i.e., the cover is not permanently affixed) attachment hardware, including but not limited to: (1) protrusions that fit into the stake holders of the top rail, (2) clips and/or hooks, which may or may not be attached to straps (e.g., one size, adjustable, rubberized with stretching properties) and/or bungee cords, that attach to a portion of the pickup truck (e.g., under the top rails, under the rear side panels, under the top rails and under the rear side panels), (3) magnetic portions that interact with the side panel, top rail, and/or inside of the bed, (4) other attachment hardware (e.g., hook and loop fasteners (e.g., Velcro), snaps, and/or other temporary, easily removable fasteners), (5) the weight of the cover, and/or (5) combinations of these.

The temporary attachment hardware embodiments may be provided on the side of the truck, inside the bed, on the rail, and/or on the cab of the pickup truck. It is important in order to obtain certain of the advantages of this invention, including the folding of the cover, the ease of installation and removal, and the ease of storage, that the attachment hardware not permanently affix any portion of the cover to the pickup truck. The attachment hardware itself may be permanently affixed to the cover and/or the pickup truck, but the cover itself is not permanently affixed. As an example, the male side of a snap may be permanently attached to the pickup truck and the female side of a snap may be permanently attached to the cover, but the snaps are not intended to permanently affix the cover onto the pickup truck.

As an example of how the temporary attachment hardware can be used, four (or more or less) clips can be attached to the inner portion of an embodiment of this invention. These clips can clip onto the underside of the top rail of the pickup bed and thereby hold the cover onto the pickup truck. As another example of how the temporary attachment hardware can be used, magnetic strips can be attached on the underside of the cover to hold it on to the pickup truck. As another example of how the temporary attachment hardware can be used, one or more hook and loop fasteners (e.g., Velcro) can be attached on the underside of the cover and the corresponding part of the inside of the pickup truck bed to hold it onto the pickup truck. A person of skill in the art will know several other ways the temporary attachment hardware described herein can be used to attach a cover to the pickup truck rear side panel.

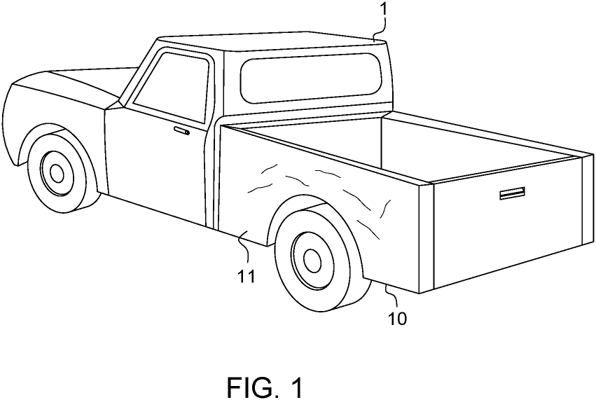

FIG. 1 shows scratch damage to the driver side 10 rear side panel 11 of a pickup truck 1 from the loading of debris into the bed that this invention is designed to avoid.

The top drawing of FIG. 2 is an embodiment of this invention as seen from a front (outside the bed), partially off center viewpoint of a driver side rear side panel cover 20 of this invention. The cover 20 has an inside portion 21 (also called inside rail portion herein) that covers the inside portion of the top rail of the pickup truck bed, a top rail portion 22 that covers the drivers side top rail of the pickup truck bed, and an outside portion 23 that covers the rear side panel of the pickup truck. The three portions are connected to one another to form one continuous cover.

The bottom drawing of FIG. 2 is an embodiment of this invention as seen from a back (inside the bed), partially off center viewpoint of a passenger side rear side panel cover of this invention. The cover 30 has an inside portion 31 that covers the inside portion of the top rail of the pickup truck bed, a top rail portion 32 that covers the passenger side top rail of the pickup truck bed, and an outside portion 33 that covers the rear side panel of the pickup truck. The three portions are connected to one another to form one continuous cover.

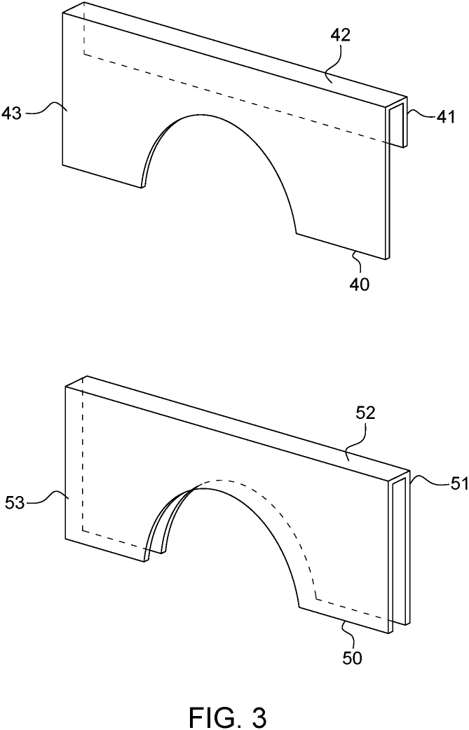

FIG. 3 shows two additional exemplary embodiments of this invention, each from a front (outside the bed), partially off center viewpoint of two driver side rear side panel covers of this invention.

The top drawing of FIG. 3 is an embodiment of this invention as seen from a front (outside the bed), partially off center viewpoint of a driver side rear side panel cover 40 of this invention. The cover 40 has an inside portion 41 that covers the inside portion of the top rail of the pickup truck bed and a portion of the inside of the bed of the pickup truck bed, a top rail portion 42 that covers the drivers side top rail of the pickup truck bed, and an outside portion 43 that covers the rear side panel of the pickup truck. The three portions are connected to one another to form one continuous cover.

The bottom drawing of FIG. 3 is an embodiment of this invention as seen from a front (outside the bed), partially off center viewpoint of a driver side rear side panel cover 50 of this invention. The cover 50 has an inside portion 51 that covers the inside portion of the top rail of the pickup truck bed and a portion of the inside of the bed of the pickup truck bed, a top rail portion 52 that covers the drivers side top rail of the pickup truck bed, and an outside portion 53 that covers the rear side panel of the pickup truck. The three portions are connected to one another to form one continuous cover.

The bottom drawing of FIG. 3 shows an embodiment that covers more of the inside of the bed of the pickup truck bed than the embodiment shown in the top drawing of FIG. 3.

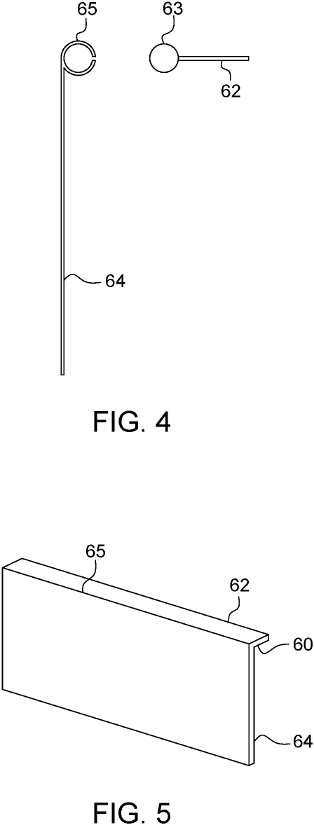

Certain preferred embodiments comprise an outside portion of the cover and a top rail portion of the cover (with or without an inside rail portion) that are connected to one another by an interlocking structure. An example of these preferred embodiments is shown in FIG. 4. On the left side, this figure shows a cross-section of the outside portion 64 of the cover attached to one piece of the interlocking structure, a hollow, partial circle round piece 65. On the right side, this figure shows a cross-section of the top rail portion 62 of the cover attached to the other piece of the interlocking structure, a solid tube piece 63. The hollow, partial circle round piece 65 is fitted to slide over the solid tube piece 63 along the length of the rear panel of the truck, and thereby hang the outside cover 64 over the rear panel.

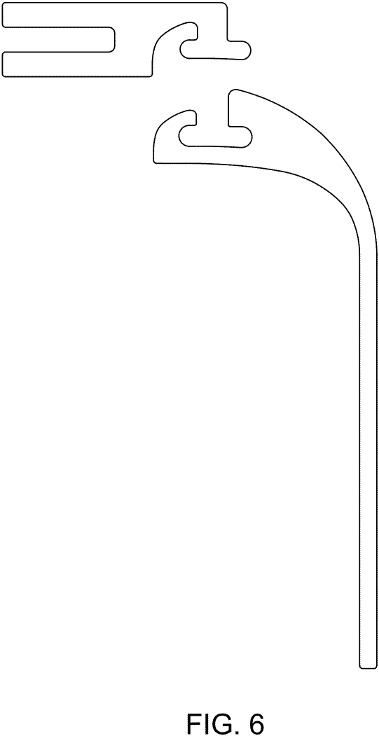

The components of these particular preferred embodiments attached to one another to form a cover of this invention 60 is shown in FIG. 5, where the interlocking pieces have been joined, the hollow, partial circle round piece 65 is visible and the outside portion 64 is thereby attached to the top rail portion 62. The top rail portion 62 is preferably slipped under the plastic protective rail piece found on many pickup trucks, or is otherwise attached to the rail. In certain of these embodiments, an inside portion (not shown) is attached (e.g., sewn, glued, riveted, welded, screwed) to the top rail portion to help hold it in place and/or provide some protection to the inside of the bed.

Certain of the particularly preferred embodiments of this invention comprise a cover for a rear side panel of a pickup truck. These covers comprise (a) an outside portion that covers all or substantially all of the rear side panel; (b) a top rail portion that covers all or substantially all of the top part of the top rail of the rear side panel; (c) an optional inside portion that covers all or substantially all of the inside portion of the top rail of the rear side panel; and (d) wherein the outside portion, top rail portion, and optional inside portion are connected to form one continuous cover and they provide protection against scratches and dents to the rear side panel when the bed of the pickup truck is being loaded and/or unloaded.

Certain of the preferred embodiments of this invention use at least three parts (e.g., interlocking structure, pieces, panels, sections, or portions) that are attached to one another and the cover portions are one-layer of material. Using one-layer of material may aid or otherwise facilitate the facile removal, installing and/or uninstalling of the temporary cover of this invention and in the folding and storage of the cover.

The preferred embodiments of this invention are covers, or portions of covers, that are foldable so that they can be stored when the pickup truck is not being loaded and/or unloaded.

The preferred embodiments of this invention provide a temporary cover that is not permanently affixed to the pickup truck. These covers are removed before highway use or when driving down the road for a substantial period of time (i.e., more than five minutes and not just for short changes of position while loading and/or unloading). The embodiments of this invention are not intended to be covers that are permanently affixed to the pickup truck or covers that are used when the pickup truck is being driven down the highway or for substantial periods of time (as defined supra).

The preferred embodiments of this invention are also easily removable, easily installed and/or easily uninstalled. By “easily removable,” “easily installed,” and “easily uninstalled” it is meant that the cover can be removed (or installed or uninstalled) in less than one minute by an average adult person. The preferred embodiments of this invention are also easily storable. By “easily storable” it is meant that at least the outside portion of the cover is foldable and it can be folded into a size that is less than 3 cubic feet so that it can be stored in or on the pickup truck if desired.

As used herein, “all” in reference to a surface is meant to mean about 100% of the surface that is being described. The phrase “substantially all” in reference to a surface is meant to include more than about 60% of the surface that is being described. The words “about 100%” can be substituted for the word “all.” The phrase “about 60%” can be substituted for the phrase “substantially all.” Thus, the phrase “all or substantially all” when used herein also means “about 60% to about 100%.”

In certain of these preferred embodiments, the cover further comprises temporary attachment hardware that temporarily attaches the cover to the rear side panel, the top rail, the inside of the top rail, and/or some other portion of the pickup truck.

Another set of the particularly preferred embodiments of this invention includes kits that comprise two covers, one for the driver side rear side panel of a pickup truck and one for the passenger side rear side panel of a pickup truck. These kits comprise: (a) a first cover comprising an outside portion that covers all or substantially all of the driver side rear side panel of the pickup truck, a top rail portion that covers all or substantially all of the top part of the top rail of the driver side rear side panel of the pickup truck, and an optional inside portion that covers all or substantially all of the inside portion of the top rail of the driver side rear side panel, wherein the outside portion, top rail portion, and optional inside portion of the first cover are connected to form one continuous cover and they provide protection against scratches and dents to the driver side rear side panel when the bed of the pickup truck is being loaded and/or unloaded.

These kits also comprise (b) a second cover comprising an outside portion that covers all or substantially all of the passenger side rear side panel of the pickup truck, a top rail portion that covers all or substantially all of the top part of the top rail of the passenger side rear side panel of the pickup truck, and an optional inside portion that covers all or substantially all of the inside portion of the top rail of the passenger side rear side panel, wherein the outside portion, top rail portion, and optional inside portion of the second cover are connected to form one continuous cover and they provide protection against scratches and dents to the passenger side rear side panel when the bed of the pickup truck is being loaded and/or unloaded.

The first cover and second cover are each temporary, not permanently affixed to the pickup truck, comprised of at least three parts attached together, easily removable, easily installed and uninstalled, foldable, and easily storable, as described supra.

In certain of these particularly preferred embodiments that comprise kits, the kits further comprise (1) attachment hardware that temporarily attaches the first cover to the driver side rear side panel and/or the driver side top rail of the pickup truck, and (2) attachment hardware that temporarily attaches the second cover to the passenger side rear side panel and/or the passenger side top rail of the pickup truck.

In still other preferred embodiments of this invention, a cover for a rear side panel of a pickup truck that has at least one bed rail cap is provided. The cover comprises (a) an outside portion that covers all or substantially all of the rear side panel; (b) a first interlocking piece and a second interlocking piece that when fitted together form an interlocking structure; (c) the first interlocking piece is part of the bed rail cap; (d) the second interlocking piece is part of the top of the outside portion; (e) wherein the outside portion is one-layer of material and it provides protection against scratches and dents to the rear side panel when the bed of the pickup truck is being loaded and/or unloaded; and (f) wherein the outside portion of the cover is foldable, temporary, not permanently affixed, easily installed and uninstalled by being installed in less than one minute by an average adult person and uninstalled in less than one minute by an average adult person, and easily storable by folding it up to a volume of less than 3 cubic feet. A kit may be provided comprising two of these covers, one for the right side of the pickup truck, and one for the left side of the pickup truck.

In addition, a pickup truck bed rail cap of this invention can be provided. The cap comprises a plastic or rubber-like material that attaches to the top rail of a pickup truck bed. The cap contains a first interlocking piece (i.e., this piece is attached or embedded or otherwise a part of the cap) that can be fitted with a second interlocking piece, the second interlocking piece having an attached cover for the outside portion of the rear side panel of the pickup truck.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

We claim:

1. A cover for a rear side panel of a pickup truck, the cover comprising:
(a) an outside portion that covers all or substantially all of the rear side panel;
(b) a top rail portion that covers all or substantially all of the top part of the top rail of the rear side panel;
(c) an inside portion that covers a portion or all or substantially all of the inside portion of the top rail of the rear side panel;
(d) wherein the outside portion, top rail portion, and inside portion are each one-layer of material, they are connected to form one continuous cover, and they provide protection against scratches and dents to the rear side panel when the bed of the pickup truck is being loaded and/or unloaded; and
(e) wherein the cover is foldable, temporary, not permanently affixed, easily installed and uninstalled by being installed in less than one minute by an average adult person and uninstalled in less than one minute by an average adult person, and easily storable by folding it up to a volume of less than 3 cubic feet.

2. The cover of claim 1 further comprising attachment hardware that attaches the cover to the rear side panel and/or the top rail of the pickup truck, the attachment hardware providing a temporary, not permanent attachment of the cover to the pickup truck, so that the covers can be quickly and easily installed and uninstalled.

3. A kit comprising two of the covers of claim 1, one for the right side of the pickup truck, and one for the left side of the pickup truck.

4. The kit of claim 3 further comprising (1) first attachment hardware that attaches the first cover to the driver side rear side panel and/or the driver side top rail of the pickup truck, and (2) second attachment hardware that attaches the second cover to the passenger side rear side panel and/or the passenger side top rail of the pickup truck, the first and second attachment hardware providing a temporary, not permanent attachment of the first and second cover to the pickup truck, so that the first and second covers can be quickly and easily installed and uninstalled.

5. A cover for a rear side panel of a pickup truck, the cover comprising:
(a) an outside portion that covers all or substantially all of the rear side panel;
(b) a top rail portion that covers all or substantially all of the top part of the top rail of the rear side panel;
(c) an inside portion attached to the top rail portion that hangs inside the pickup bed.
(d) an interlocking structure comprising a first interlocking piece and a second interlocking piece;
(e) the first interlocking piece comprising a solid tube that is attached to the length of the top rail portion;
(f) the second interlocking piece comprising a hollow, partial circle round piece that is attached to the length of the outside portion, said second interlocking piece fitted to enclose the first interlocking piece along its length and thereby connect the outside portion to the top rail portion;
(g) wherein the outside portion, top rail portion and inside portion are each one-layer of material, they are connected to form one continuous cover, and they provide protection against scratches and dents to the rear side panel when the bed of the pickup truck is being loaded and/or unloaded; and
(h) wherein at least the outside portion of the cover is foldable, temporary, not permanently affixed, easily installed and uninstalled by being installed in less than one minute by an average adult person and uninstalled in less than one minute by an average adult person, and easily storable by folding it up to a volume of less than 3 cubic feet.

6. The cover of claim 5 wherein the top rail portion is fitted to go under a plastic protector on the top rail of a pickup truck.

7. The cover of claim 5 further comprising attachment hardware that attaches the cover to the rear side panel and/or the top rail of the pickup truck, the attachment hardware providing a temporary, not permanent attachment of the cover to the pickup truck, so that the covers can be quickly and easily installed and uninstalled.

8. A kit comprising two of the covers of claim 5, one for the right side of the pickup truck, and one for the left side of the pickup truck.

9. A cover for a rear side panel of a pickup truck, the cover comprising:
(a) an outside portion that covers all or substantially all of the rear side panel;
(b) a top rail portion that covers all or substantially all of the top part of the top rail of the rear side panel;
(c) an interlocking structure comprising a first interlocking piece and a second interlocking piece;
(d) the first interlocking piece comprising a solid tube that is attached to the length of the top rail portion;
(e) the second interlocking piece comprising a hollow, partial circle round piece that is attached to the length of the outside portion, said second interlocking piece fitted to enclose the first interlocking piece along its length and thereby connect the outside portion to the top rail portion;
(f) wherein the outside portion and top rail portion are each one-layer of material, they are connected to form one continuous cover, and they provide protection against scratches and dents to the rear side panel when the bed of the pickup truck is being loaded and/or unloaded; and
(g) wherein at least the outside portion of the cover is foldable, temporary, not permanently affixed, easily installed and uninstalled by being installed in less than one minute by an average adult person and uninstalled in less than one minute by an average adult person, and easily storable by folding it up to a volume of less than 3 cubic feet.

10. The cover of claim 9 further comprising an inside portion attached to the top rail portion that hangs inside the pickup bed.

11. The cover of claim 9 wherein the top rail portion is fitted to go under a plastic protector on the top rail of a pickup truck.

12. The cover of claim 9 further comprising attachment hardware that attaches the cover to the rear side panel and/or the top rail of the pickup truck, the attachment hardware providing a temporary, not permanent attachment of the cover to the pickup truck, so that the covers can be quickly and easily installed and uninstalled.

13. A kit comprising two of the covers of claim 9, one for the right side of the pickup truck, and one for the left side of the pickup truck.

14. A cover for a rear side panel of a pickup truck that has at least one bed rail cap, the cover comprising:
(a) an outside portion that covers all or substantially all of the rear side panel;
(b) a first interlocking piece and a second interlocking piece that when fitted together form an interlocking structure;
(c) the first interlocking piece is part of the bed rail cap;
(d) the second interlocking piece is part of the top of the outside portion;
(e) wherein the outside portion is one-layer of material and it provides protection against scratches and dents to the rear side panel when the bed of the pickup truck is being loaded and/or unloaded; and
(f) wherein the outside portion of the cover is foldable, temporary, not permanently affixed, easily installed and uninstalled by being installed in less than one minute by an average adult person and uninstalled in less than one minute by an average adult person, and easily storable by folding it up to a volume of less than 3 cubic feet.

15. A kit comprising two of the covers of claim 14, one for the right side of the pickup truck, and one for the left side of the pickup truck.

16. A pickup truck bed rail cap, the cap comprising a plastic or rubber-like material that attaches to the top rail of a pickup truck bed, the cap containing an interlocking piece for attaching a cover for the outside portion of the rear side panel of the pickup truck.
